(19) United States
(12) Patent Application Publication
(10) Pub. No.: US 2016/0323267 A1
(43) Pub. Date: Nov. 3, 2016

(54) METHOD AND SYSTEM FOR ONE-TIME PASSWORD GENERATION AND DISPLAY

(71) Applicant: College of William and Mary, Williamsburg, VA (US)

(72) Inventors: Kun Sun, Virginia Beach, VA (US); He Sun, Beijing (CN)

(21) Appl. No.: 15/079,348

(22) Filed: Mar. 24, 2016

Related U.S. Application Data
(60) Provisional application No. 62/138,218, filed on Mar. 25, 2015.

(51) Int. Cl. H04L 29/06; G06F 21/57

(52) U.S. Cl. CPC H04L 63/0838; H04L 63/107; G06F 21/575; H04L 63/0846

(57) ABSTRACT

A system and method are provided for the on-demand generation and display of a one-time password (OTP). A display is coupled to a computing device having at least one user-controlled hardware input device for generating a non-maskable interrupt (NMI). The computing device has an architecture that includes an unsecure processing domain and a secure processing domain. The present invention includes an interrupt handler, an OTP generator, a display driver, and a display controller, each of which is installed in the secure processing domain. The display controller shares control of the display with the unsecure processing domain. When the interrupt handler detects an NMI interrupt, the computing device switches to the secure processing domain where an OTP is generated. The display controller assumes control of the display to display the OTP on a portion of the display while suspending updates to a remainder of the display.

### CROSS-REFERENCE TO RELATED APPLICATIONS

Pursuant to 35 U.S.C. §119, the benefit of priority from provisional application Ser. No. 62/138,218, with a filing date of Mar. 25, 2015, is claimed for this non-provisional application.

### STATEMENT REGARDING FEDERALLY SPONSORED RESEARCH AND DEVELOPMENT

This invention was made with government support under Grant No. N00014-15-1-2012 awarded by the Office of Naval Research. The government has certain rights in the invention.

### FIELD OF INVENTION

The field of the invention relates to methods and systems for providing one-time passwords on mobile computing devices such as smartphones, smartwatches and tablets.

### BACKGROUND OF THE INVENTION

The number of remote-access users of corporate and government networks is substantial and is growing. For example, by the end of 2015, estimates indicate that more than 1.3 billion workers worldwide routinely work outside of a traditional office environment. Mobile computing devices such as smartphones, smartwatches, tablets, etc., are widely used to perform business transactions by mobile workers.

Organizations being accessed remotely have traditionally used two-factor authentication to secure a user's remote access to organizational resources. Due to their ease of use, one-time password (OTP) technology is widely deployed in two-factor authentication solutions. An OTP is an automatically generated numeric or alphanumeric string of characters that authenticate a user for a single transaction or session to an authentication server. An OTP augments the traditional user ID and password system by providing an additional, dynamic password that changes frequently.

An OTP mechanism consists of a token that can be either hardware-based (e.g., pocket-size fobs) or software-based (e.g., a soft token). Software-based OTP mechanisms can generate an OTP using a built-in clock (or counter) and a factory-encoded secret key. The secret key is also known as the “seed”. The seed is different for each token and is stored in the corresponding authentication server that is to be accessed. Hardware tokens are typically more secure than software tokens, but the downside of hardware tokens is that the user needs to carry an extra device, e.g., a fob. Moreover, there is an additional cost for physical hardware token. Soft tokens are more convenient for use; however, security is a greater concern as the secret keys may be released and duplicated due to the lack of tamper-resistant protection in the software.

OTP generators can be installed into smartphones as software apps. Moreover, the smartphone can help distribute OTPs by receiving “short message service” (SMS) or email messages containing the OTP generated by the authentication server. Due to the popularity of smartphones, this software-based OTP brings no extra physical/hardware burden to the user since the user typically already has a smartphone. However, soft tokens face two main security challenges. First, when the mobile operating system is compromised, a soft token cannot guarantee the confidentiality of the generated OTPs or even the seed. For instance, the attacker may steal the OTP by taking screenshots that contain the OTP displayed on the screen. If the OTP app or the SMS app has been instrumented, the instrumented code can actively send the OTP out to the attacker. Moreover, the rootkits in mobile operating systems can steal the OTP seed through inspection of the system memory. Second, a soft token can suffer from denial-of-service attacks, and it can hardly ensure the availability of the OTP generation when the OTP is required. A malicious operating system (OS) can tamper with or simply delete the OTP code in the memory or the permanent storage, so that the OTP generator cannot successfully run. When the OS crashes, the OTP is not accessible either. For the OTP received by SMS or email, the OTP cannot be accessed when there is no cellular signal or internet connection.

### BRIEF SUMMARY OF THE INVENTION

Accordingly, it is an object of the present invention to provide a method and system for the generation and display of OTPs.

Another object of the present invention is to provide a method and system for generating and displaying OTPs on a mobile computing device while making the OTP secure from cyber attacks.

In accordance with the present invention, a system and method are provided for the on-demand generation and display of a one-time password (OTP). A display is coupled to a computing device having at least one user-controlled hardware input device for generating a non-maskable interrupt (NMI). The computing device has an architecture that includes an unsecure processing domain and a secure processing domain wherein hardware and software in the secure processing domain is not accessible to the unsecure processing domain. The present invention includes an interrupt handler installed in the secure processing domain and adapted to be coupled to the at least one hardware input device. An OTP generator installed in the secure processing domain is coupled to the interrupt handler. A display driver installed in the secure processing domain is coupled to the OTP generator and is adapted to be coupled to the display. A display controller installed in the secure processing domain is coupled to the OTP generator. The display controller is adapted to be coupled to the display for shared control of the display with the unsecure processing domain. When the interrupt handler detects the NMI interrupt, the computing device switches to the secure processing domain. The OTP generator then generates an OTP in the secure processing domain, and the display controller assumes control of the display to display the OTP on a portion of the display while suspending updates to a remainder of the display. The image on the remainder of the display is generated by the unsecure processing domain.

### BRIEF DESCRIPTION OF THE DRAWINGS

The summary above, and the following detailed description, will be better understood in view of the drawings that depict details of preferred embodiments.

FIG. 1 is a schematic diagram of a mobile device that includes a secure one-time password (OTP) generation and display system in accordance with an embodiment of the present invention;

FIG. 2 is a schematic diagram of a boot sequence for the secure OTP generation and display system;

FIG. 3 is a schematic diagram of a OTP generator with its clock and counters in a secure processing domain in accordance with an embodiment of the present invention; and

FIG. 4 is a schematic diagram of a screen display partitioned for display of an OTP in accordance with the present invention.

### DETAILED DESCRIPTION OF THE INVENTION

The present invention is a hardware-based method and system for the on-demand generation and display of one-time passwords (OTP) for an authentication server having the same secret key or “seed” used in the present invention's OTP generation. The method and system can be implemented on a variety of mobile computing and communication devices (hereinafter referenced to simply as mobile devices) to include, but not limited to, smartphones, smartwatches and tablets. The present invention can be installed on existing mobile devices or can be included in the design of new mobile devices without departing from the scope of the present invention. The method and system can be realized by an arrangement of hardware and/or software modules to control the generation and display of OTPs on a mobile device.

For purposes of the present invention, a mobile device is assumed to have an architecture that provides a system-level isolation for the mobile device's system resources that includes a central processing unit (CPU), memory, direct memory access (DMA), and peripherals. In general, the system-level isolation is defined by a known architecture that provides two execution domains, namely, an unsecure processing domain and a secure processing domain. The unsecure processing domain is also referred to in the art as the “normal domain,” and the secure processing domain is also referred to in the art as the “secure domain.” For ease of description, the phrases “normal domain” and “secure domain” will be used hereinafter.

One such system-level isolation employing a normal domain and secure domain architecture is known in the art as TRUSTZONE and is available commercially from Arm Inc., San Jose, California. Briefly, TRUSTZONE technology is a system-wide security approach that provides hardware-level isolation between two execution domains: the normal domain and the secure domain, both of which share the CPU in a time-sliced fashion. TRUSTZONE provides a system-level isolation on various hardware components. The secure domain has a higher access privilege than the normal domain so the secure domain can access the resources of the normal domain such as memory, CPU registers, and peripherals, but not vice versa.

TRUSTZONE includes a bit (called the “NS bit”) in the CPU processor to control and indicate the state of the CPU. There is an additional CPU mode (known as monitor mode) which only runs in the secure domain regardless of the value of the NS bit. The memory address is partitioned into a number of memory regions, which are marked as either secure or non-secure by the TRUSTZONE Address Space Controller (TZASC). Only secure transactions can access the secure memory regions but the non-secure memory regions are open to all the transactions.

TRUSTZONE supports secure and non-secure interrupts. The normal domain is prevented from configuring the interrupt source of the secure domain. The Generic Interrupt Controller (GIC) is the underlying hardware device that manages the interrupt sources. Every interrupt is marked either secure or non-secure. GIC only signals an IRQ interrupt for the non-secure interrupt and signals either IRQ or FIQ for the secure interrupt. The device's privilege is configured in the TRUSTZONE Protection Controller (TZPC) that dedicates one bit to every independent device. This bit stands for the security state of the device when the device acts as slave in bus transactions. For devices that are able to act as a master in a bus transaction, there is one more bit to show whether the device is secure or non-secure.

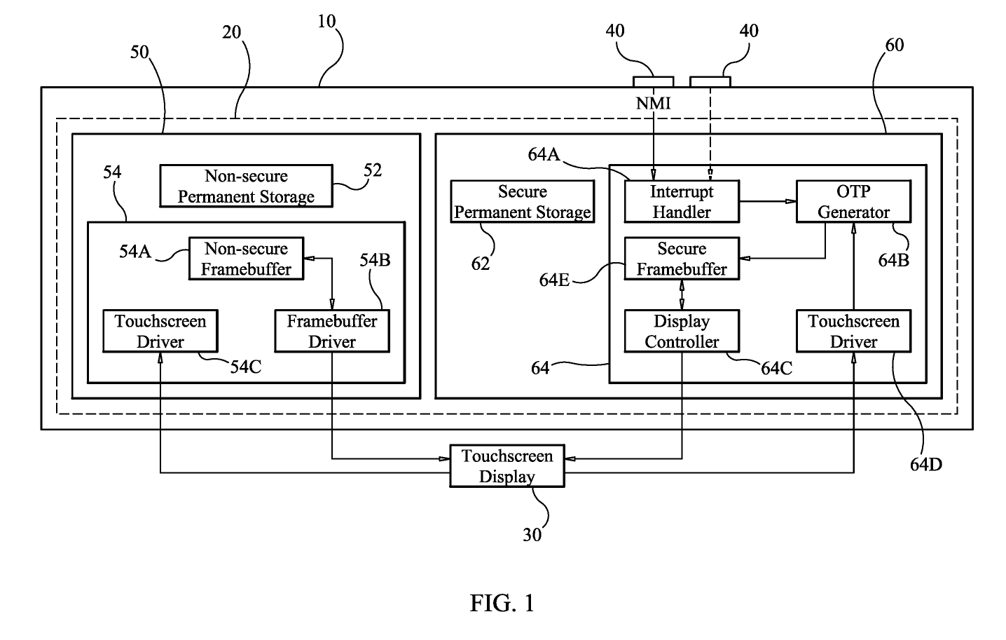

Referring now to the drawings and more particularly to FIG. 1, a mobile device 10 (e.g., smartphone, smartwatch, tablet, etc.) is shown schematically to include the elements required for the on-demand generation and display of OTP in accordance with an embodiment of the present invention. By way of an illustrated embodiment, on-demand generation and display of OTP is implemented as an arrangement of software modules installed on mobile device 10. However, it is to be understood that the various modules described herein could also be implemented in dedicated hardware without departing from the scope of the present invention.

In general and as is well-known in the art, mobile device 10 includes a processing architecture 20, touchscreen display 30, and one or more hardware-based and user-controllable input devices 40 (e.g., button, slide switches, etc.) on external areas of mobile device 10. For purposes of the present invention, it is assumed that processing architecture 20 includes the above-described system-level isolation providing a normal domain 50 and a secure domain 60.

Normal domain 50 includes non-secure permanent storage 52 for storage of an operating system (OS) 54 to run apps on mobile device 10 as is known in the art. OS 54 boots up into normal domain 50 when mobile device 10 is powered up. OS 54 defines (among other things) modules that control display 30 and can interpret user inputs made on display 30. For those functions, OS 54 includes a non-secure framebuffer 54A, a framebuffer driver 54B, and a touchscreen driver 54C. Briefly, framebuffer 54A stores display data provided to framebuffer driver 54B for presentation to/on display 30, while touchscreen driver 54C interprets user touches on display 30 indicative of a function option presented on display 30.

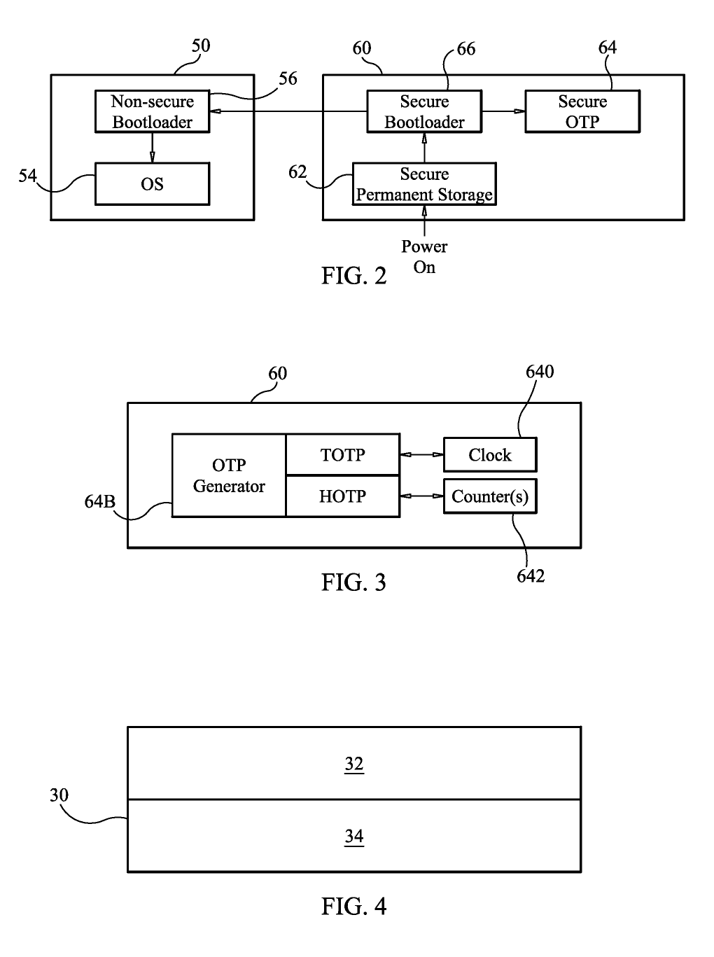

Secure domain 60 includes secure permanent storage 62 for storage of a secure OTP generation and display system 64 (hereinafter referred to simply as “secure OTP 64”) in accordance with an embodiment of the present invention. Secure OTP 64 boots up from secure permanent storage 62 when mobile device 10 is powered up. Briefly and with reference to FIG. 2, secure OTP 64 is loaded into and maintained in secure domain 60 when mobile device 10 boots up. The boot sequence depicted in FIG. 2 shows that the code on secure permanent storage 62 runs first after the mobile device powers on. Specifically, a secure bootloader 66 is loaded from secure permanent storage 62 to the memory (not shown) of secure domain 60. Then, secure bootloader 66 gains control and initializes secure domain 60. Next, secure bootloader 66 loads secure OTP 64 from secure permanent storage 62 to the memory of secure domain 60, and loads a non-secure bootloader 56 into the memory (not shown) of normal domain 50. Finally, secure bootloader 66 changes the mobile device's CPU from the secure state to the non-secure state and jumps to non-secure bootloader 56. Non-secure bootloader 56 initializes normal domain 50 and boots OS 54 to run in normal domain 50. Since secure OTP 64 is loaded before OS 54, secure OTP 64 will stay in memory regardless of the status of OS 54.

As is known in the art, secure permanent storage 62 is only accessible in secure domain 60. The data stored on secure permanent storage 62 remains unchanged after the system is restarted. If secure domain 60 is to be used infrequently, it may be inefficient to reserve a large amount of dedicated secure permanent storage for the secure domain. If this is the case, many existing platforms only provide a small amount of secure permanent storage. One form of secure permanent storage is the e-fuse. E-fuse storage can only be written to once by a secure domain, and afterwards only the secure domain can read from the blown e-fuses. Additionally, on-chip keys can be embedded on the platform upon manufacture, and those keys can only be read by the secure domain and not be written by either domain.

Secure OTP 64 includes an interrupt handler 64A, an OTP generator 64B, a display controller 64C, and a touchscreen display driver 64D. As will be explained further below, secure OTP 64 can also include a framebuffer 64E. All of secure OTP 64 is installed in secure domain 60 in order to be protected from any attack coming from a compromised or malicious OS 54. As will be explained further below, since secure OTP 64 is isolated from OS 54, the confidentiality and integrity of any generated OTPs cannot be compromised by OS 54. Further, OS 54 cannot access secure permanent storage 62 thereby protecting the integrity of OTP generator 64B and the secret key(s) or seed(s) that it uses.

An OTP is usually demanded when a user performs an online transaction or logs onto an authentication system. When this happens, OS 54 should be suspended for a short time to allow the mobile device to switch processing into secure domain 60 where OTPs can be generated and displayed in accordance with the present invention. In order to prevent a compromised or malicious OS 54 from blocking this switching operation, the present invention employs interrupt handler 64A that is configured to detect or be triggered when a user activates one or more of input devices 40. Activation of input device(s) 40 generates a non-maskable interrupt (NMI) (i.e., a hardware interrupt). When interrupt handler 64A detects the NMI, secure domain processing begins and continues until OTP generation/display is complete or until the user exits the OTP generation process.

OTP generator 64B is responsible for computing OTPs and can support one or more categories of OTP generation such as a time-based OTP (TOTP) and an event-based OTP (HOTP). There are various implementations of TOTP and HOTP algorithms. In general, a clock time is indispensable to TOTP and a counter is indispensable to HOTP. For example and as shown in FIG. 3, OTP generator 64B can read the current clock time from a secure clock 640 when generating a time-based OTP. For HOTP, OTP generator 64B maintains and depends on counter(s) 642 to calculate the OTP. Both clock 640 and counter(s) 642 are maintained in secure domain 60.

As would be understood by one of ordinary skill in the art, secure OTP 64 and the authentication server (not shown but receiving the OTP) share the same OTP generation algorithm and the same secret key so that both parties will generate the same OTP when the generation code and the keying material is well protected. In the present invention, the generation code is well-protected on secure permanent storage 62 against a malicious OS 54. This prevents the static code from being manipulated by OS 54. Further, OS 54 is prevented from deleting the code from secure permanent storage 62. Finally, the present invention loads the OTP generation code into secure memory thereby preventing OS 54 from accessing the sensitive information directly from the memory.

By using secure clock 640 as the time source of TOTP, its value cannot be modified by OS 54. Typically, clock 640 is powered by an independent power source such as a dedicated cell battery (not shown). Each HOTP has a corresponding counter 642 that increments as the HOTP is updated. Only secure domain 60 has the privilege to access counters 642. Normal domain 50 cannot modify counters 642. The value of counters 642 can be saved after the mobile device is powered down. Secure counters 642 can be real physical modules that run on independent power source and increment by one on demand, or they can be numbers stored on secure permanent storage 62 that are updated every time the corresponding HOTP is updated.

Secure OTP 64 can be configured to support multiple OTP instances that use the same OTP algorithm but different keys. For simplicity, it is assumed herein that the authentication system uses the same algorithms to calculate the OTP as secure OTP 64. To dynamically add a new OTP instance, the user would register in the corresponding authentication system and obtain a shared secret key for TOTP or a counter plus a key for HOTP. Next, the user would input the shared keying information to the mobile device. Since OS 54 cannot be trusted, the present invention provides a trusted user-input interface in secure domain 60 to initiate the OTP. The trusted user-input interface is self-contained touchscreen display driver 64D installed in secure domain 60.

Once the OTP is generated, the OTP must be displayed for the user. In general and as shown schematically in FIG. 4, the present invention displays the OTP on display 30 in a dedicated portion 32 thereof at the same time that the remaining portion 34 thereof is not related to the OTP. (It is to be understood that the size and shape of portion 32 and remainder 34 are not limitations of the present invention.) More specifically, secure OTP 64 assumes control of display 30 to present the OTP on display portion 32 while suspending updates to display 30 by OS 54. To keep the user engaged with the app running on OS 54, remaining portion 34 of display 30 is frozen at the point the OTP was requested, i.e., when the user generated the NMI. Since control of display portion 32 and the contents sent to and displayed on display portion 32 originate from secure domain 60, OS 54 cannot “see” the content on display portion 32. Furthermore, since updates to remainder portion 34 by OS 54 are suspended, OS 54 cannot be manipulated to take a “screen shot” of display portion 32 and the display OTP. Display controller 64C controls display 30 during OTP generation/display, and relinquishes control of display 30 (to OS 54) at the conclusion of OTP generation/display or when a user provides an input indicative of a desire to exit OTP generation/display (e.g., via execution of an option or “button” presented on display portion 32).

Secure OTP 64 allows the OTP to be securely generated and securely displayed on display portion 32, i.e., outside the reach of OS 54. As mentioned above, OTP 64 can also include its own framebuffer 64E to store generated OTPs for secure transfer to display controller 64C. Framebuffer 64E can store the image of the OTP that is to be displayed in order to provide for intermittent display of the OTP as will be explained later herein. To securely receive user inputs made via options/buttons presented on display portion 32, touchscreen display driver 64D is included in secure OTP 64. A variety of display controllers and touchscreen display drivers can be used without departing from the scope of the present invention.

When secure OTP 64 is running, OS 54 will be suspended until secure OTP 64 exits. Therefore, if the OTPs are being displayed for a continuous time, the mobile device user cannot perform any app operations in OS 54 during such continuous time. In this type of embodiment of the present invention where the user needs to input the OTPs into apps running on the mobile device, the user must remember the OTP before secure OTP 64 exits and then input the remembered OTP in the app running on OS 54.

To make it convenient for the user to enter the generated/displayed OTP locally on the mobile device, the present invention can include an intermittent display method that displays the OTP on display portion 32 for a short time, and then repeats such OTP display intermittently using a specified time interval until the user finishes inputting the OTPs into the app(s) running on OS 54. In this type of display embodiment, OS 54 and secure OTP 64 run alternately such that the control of display 30 by secure domain 60 and normal domain 50 correspondingly alternates during the course of an OTP generation/display in accordance with the present invention. The displayed OTP need only be calculated once at the first entry to secure OTP 64 with the generated OTP being stored in framebuffer 64E. In subsequent/intermittent entries to secure OTP 64, secure OTP 64 just needs to display the generated OTP stored on framebuffer 64E. The time interval between two rounds of displays and the length of time that the OTP is displayed (or OTP display time) are configurable. The time interval between displays of the OTP should be short enough to prevent the user from waiting for the next display. The OTP display time should be short enough to prevent the user from waiting for OS 54 to run the app. However, the OTP display time must be long enough for the user to see the OTP clearly on display portion 32. For example, the OTP display time will generally be in the range of longer than 1/24 second due to the well-known phi phenomenon, and less than approximately 1 second. After the user inputs the OTP, the user can actively exit secure OTP 64 by selecting an exit option presented on display portion 32 as described above, or by inputting a hardware trigger on the mobile device (e.g., a repeat of the input used to generate the NMI interrupt as described above).

When the intermittent control of display 30 transfers back to OS 54 during an OTP generation/display process, secure framebuffer 64E is replaced with non-secure framebuffer 54A as the current frame buffer to show its content on display 30. When the system switches from OS 54 to secure OTP 64, display controller 64C will, in sequence, copy all the content in non-secure framebuffer 54A to secure framebuffer 64E, modify the portion of secure framebuffer 64E for the generated OTP, and set secure framebuffer 64E as the current frame buffer to show its content on the display.

The advantages of the present invention are numerous. The secure OTP generation and display can effectively prevent all the attacks on soft token-based solutions on mobile devices. The secure OTP is easy to use and is readily adaptable to a variety of OTP algorithms. All the code and data relied upon by the secure OTP are securely isolated from the mobile device's OS that is susceptible to attacks and crashing, thereby preventing the OS from compromising the confidentiality and integrity of the generated OTPs. Since the OTP generator is installed in the secure domain, the mobile device's OS running in the normal domain cannot access the OTP code, generated OTPs, or the seed(s) used to generate the OTPs. The present invention provides for the secure sharing of the mobile device's CPU and display device with the normal domain's OS in a way that prevents the leaking of sensitive information into the OS through these shared system resources. The secure OTP can ensure the availability of OTPs even if the normal OS is compromised or simply crashes. When the user needs to obtain the OTP, a non-maskable interrupt (NMI) can be triggered to switch the system into the secure domain even if the OS crashes. This NMI cannot be manipulated or disabled by the OS. When the secure OTP is running, no external interrupts can break the OTP generation or display without switching back to the normal domain. The secure OTP is self-contained and does not require any changes to the OS and is not dependent on the OS. After the system switches into the secure domain, the secure OTP saves the states of the OS for restoration before switching back to the normal domain. The secure OTP provides a display interface that can show the OTP on the OS's screen, while preventing the OS from accessing the OTP by capturing screenshots. During OTP generation/display, secure domain control of the mobile device's display can be made intermittent to allow a user to input the OTP into an app running locally in the normal domain without the user having to memorize the OTP. The present invention can be used with various OTP algorithms such as well-known event-based OTPs and time-based OTPs.

### INCORPORATION BY REFERENCE

All publications, patents, and patent applications cited herein are hereby expressly incorporated by reference in their entirety and for all purposes to the same extent as if each was so individually denoted.

### Equivalents

While specific embodiments of the subject invention have been discussed, the above specification is illustrative and not restrictive. Many variations of the invention will become apparent to those skilled in the art upon review of this specification. The full scope of the invention should be determined by reference to the claims, along with their full scope of equivalents, and the specification, along with such variations.

We claim:

1. A system for on-demand generation and display of a one-time password (OTP) on a display coupled to a computing device having at least one user-controlled hardware input device for generating a non-maskable interrupt (NMI), the computing device having an architecture that includes an unsecure processing domain and a secure processing domain wherein hardware and software in the secure processing domain is not accessible to the unsecure processing domain, said system comprising:
an interrupt handler installed in the secure processing domain and adapted to be coupled to the at least one hardware input device;
an OTP generator installed in the secure processing domain and coupled to said interrupt handler;
a display driver installed in the secure processing domain and coupled to said OTP generator, said display driver adapted to be coupled to the display; and
a display controller installed in the secure processing domain and coupled to said OTP generator, said display controller adapted to be coupled to the display for sharing control of the display with the unsecure processing domain,
wherein, when said interrupt handler detects the NMI interrupt, the computing device switches to the secure processing domain, said OTP generator generates an OTP in the secure processing domain, and said display controller assumes control of the display to display said OTP on a portion of the display while suspending updates to a remainder of the display wherein an image generated by the unsecure processing domain is displayed on said remainder of the display.

2. A system as in claim 1, wherein said display controller relinquishes said control of the display to the unsecure processing domain when said display driver receives a specified user input.

3. A system as in claim 1, further comprising buffer storage installed in the secure processing domain and coupled to said OTP generator and said display controller for storing said OTP.

4. A system as in claim 1, wherein said display driver comprises a touchscreen display driver.

5. A system as in claim 1, further comprising a clock installed in the secure processing domain and coupled to said OTP generator.

6. A system as in claim 1, further comprising a counter installed in the secure processing domain and coupled to said OTP generator.

7. A system as in claim 1, further comprising:
a clock installed in the secure processing domain and coupled to said OTP generator; and
a counter installed in the secure processing domain and coupled to said OTP generator.

8. A system for on-demand generation and display of a one-time password (OTP), comprising:
a computing device having at least one user-controlled hardware input device for generating a non-maskable interrupt (NMI), said computing device having an architecture that includes an unsecure processing domain and a secure processing domain wherein hardware and software in said secure processing domain is not accessible to said unsecure processing domain;
a display coupled to said computing device;
an interrupt handler installed in said secure processing domain and coupled to said at least one hardware input device;
an OTP generator installed in said secure processing domain and coupled to said interrupt handler;
a display driver installed in said secure processing domain and coupled to said OTP generator and said display; and
a display controller installed in said secure processing domain and coupled to said OTP generator and said display, said display controller sharing control of said display with said unsecure processing domain,
wherein, when said interrupt handler detects said NMI interrupt, said computing device switches to said secure processing domain, said OTP generator generates an OTP in said secure processing domain, and said display controller assumes control of said display to display said OTP on a portion of said display while suspending updates to a remainder of said display wherein an image generated by said unsecure processing domain is displayed on said remainder of said display.

9. A system as in claim 8, wherein said display controller relinquishes said control of said display to said unsecure processing domain when said display driver receives a specified user input.

10. A system as in claim 8, further comprising buffer storage installed in said secure processing domain and coupled to said OTP generator and said display controller, said buffer storage storing said OTP.

11. A system as in claim 8, wherein said display comprises a touchscreen and said display driver comprises a touchscreen display driver.

12. A system as in claim 8, further comprising a clock installed in said secure processing domain and coupled to said OTP generator.

13. A system as in claim 8, further comprising a counter installed in said secure processing domain and coupled to said OTP generator.

14. A system as in claim 8, further comprising:
a clock installed in said secure processing domain and coupled to said OTP generator; and
a counter installed in said secure processing domain and coupled to said OTP generator.

15. A system as in claim 8, wherein said computing device and said display are integrated into a single mobile device.

16. A method of on-demand generation and display of a one-time password (OTP) on a display, the display being coupled to a computing device having at least one user-controlled hardware input device for generating a non-maskable interrupt (NMI), the computing device having an architecture that includes an unsecure processing domain and a secure processing domain wherein hardware and software in the secure processing domain is not accessible to the unsecure processing domain, said method comprising the steps of:
detecting the NMI in the secure processing domain;
generating an OTP in the secure processing domain in response to detection of the NMI;
controlling the display from the secure processing domain in response to detection of the NMI, said step of controlling occurring at the same time a remainder of the display is controllable by the unsecure processing domain;
displaying said OTP on a portion of the display; and
suspending updates to a remainder of the display wherein an image generated by the unsecure processing domain is displayed on said remainder of the display.

17. A method according to claim 16, further comprising the steps of:
displaying user-selectable options on said portion of the display, said user-selectable options including an option to exit the secure processing domain; and
relinquishing control of the display when a user exercises said option.

18. A method according to claim 16, further comprising the step of storing said OTP in the secure processing domain.

19. A method according to claim 16, wherein said OTP comprises at least one of a time-based OTP and an event-based OTP.

20. A method according to claim 16, wherein a combination defined by said steps of controlling, displaying, and suspending occurs intermittently.

21. A method according to claim 20, wherein each said step of displaying lasts for at least 1/24 seconds and not longer than approximately 1 second.

22. In a mobile computing device having a touchscreen display, at least one user-controlled hardware input device for generating a non-maskable interrupt (NMI), and an architecture that includes an unsecure processing domain and a secure processing domain wherein hardware and software in the secure processing domain is not accessible to the unsecure processing domain, a software arrangement stored in the secure processing domain and comprising a computer program which configures the secure processing domain to perform one or more functions comprising:
detecting the NMI in the secure processing domain;
generating an OTP in the secure processing domain in response to detection of the NMI;
controlling a portion of the touchscreen display from the secure processing domain and in response to detection of the NMI;
displaying said OTP on a portion of the display; and
suspending updates to a remainder of the display wherein an image generated by the unsecure processing domain is displayed on said remainder of the display.

23. A software arrangement as in claim 22, further comprising the functions of:
displaying user-selectable options on said portion of the display, said user-selectable options including an option to exit the secure processing domain; and
relinquishing control of the display when a user exercises said option.

24. A software arrangement as in claim 22, further comprising the function of storing said OTP in the secure processing domain.

25. A software arrangement as in claim 22, wherein said OTP comprises at least one of a time-based OTP and an event-based OTP.

26. A software arrangement as in claim 22, wherein a combination of said functions of controlling, displaying, and suspending is performed intermittently.

27. A software arrangement as in claim 22, wherein each occurrence of said function of displaying lasts for at least 1/24 seconds and not longer than approximately 1 second.
